(19) United States
(12) Patent Application Publication
(10) Pub. No.: US 2017/0120423 A1
(43) Pub. Date: May 4, 2017

(54) LOCKING PLIERS

(71) Applicant: Min Wang, Hangzhou City (CN)

(72) Inventor: Min Wang, Hangzhou City (CN)

(73) Assignees: Hangzhou Great Star Tools Co., Ltd., Hangzhou City, Zhejiang Province (CN); Hangzhou Great Star Industral Co., Ltd., Hngzhou City, Zhejiang Province (CN)

(21) Appl. No.: 14/369,843

(22) PCT Filed: Jun. 20, 2014
(86) PCT No.: PCT/CN2014/080366

§ 371 Date: Jun. 30, 2014

(51) Int. Cl. B25B 7/12

(52) U.S. Cl. CPC B25B 7/123

(57) ABSTRACT

The present invention provides a pair of locking pliers, comprising a main clamp body, a movable jaw, a movable handle, a link, a wedge-shaped piece and an adjusting mechanism. When the jaw span reaches maximum, the pair of locking pliers satisfies the following relations: H/D₁≧0.5, (D₂+D₃)/D₁≦3.1, D₂/D₃≧0.45, wherein H is the distance between the center of the first pivot and the axis X of the fixed handle passed through the center of the fourth pivot, D₁ is the distance between the center of the first pivot and the center of the second pivot, D₂ is the distance between the center of the second pivot and the center of the third pivot, D₃ is the distance between the center of the third pivot and the center of the fourth pivot. The maximum opening angle of the jaw span of the invention can reach 49°, which results in the fact that the pair of locking pliers can efficiently and conveniently clamp large-size working piece. The clamping force can he adjusted and has nothing to do with the clamped working piece, which is beneficial to clamp the working pieces with different sizes. In addition, when the jaw span reaches the maximum, the angle between the movable handle and the fixed handle is relatively small, which is convenient for operating the pair of locking pliers with single hand.

### FIELD OF THE INVENTION

The present invention relates to a hardware tool and, more particularly, to a pair of locking pliers.

### DESCRIPTION OF THE PRIOR ART

Already existing locking pliers generally comprise a fixed jaw, a movable jaw, a fixed handle, a movable handle and adjusting screws. During the use of locking pliers, holding the locking mechanism can clamp the working piece and opening the locking mechanism can loosen the working piece. However, due to the opening angle is relatively small, these pliers cannot clamp large-size working pieces, which is their deficiency and limits the range of application.

### SUMMARY OF THE INVENTION

The object of the present invention is to provide a pair of locking pliers with simple structure, reasonable design, low cost and capable of holding large-size working pieces.

Another object of the invention is to provide a pair of locking pliers with a simple structure, an adjustable jaw span and a large opening of the jaw span.

A further object of the invention is to provide a pair of locking pliers with large clamping force, which is convenient for clamping large-size working pieces.

For the above purpose, the present invention provides a pair of locking pliers, comprising:
a main clamp body formed by a fixedly connection of a fixed jaw and a fixed handle, wherein the fixed handle is provided with a square channel;
a movable jaw connected with the main clamp body by a first pivot and capable of combining with the fixed jaw to form a jaw span;

a movable handle connected with the movable jaw by a second pivot and provided with a recess, wherein the recess extends along the movable handle;

a wedge-shaped piece disposed in the square channel of the fixed handle and the wedge-shaped piece which comprises a first wedge-shaped block and a second wedge-shaped block;
a link having a forward end and a rearward end, wherein the forward end of the link is connected with the movable handle by a third pivot, the rearward end of the link extends far away from the jaw span, and the rearward end is connected with the first wedge-shaped block by a fourth pivot;
wherein the pair of locking pliers is configured such that: when the jaw span reaches maximum, the pair of locking pliers satisfies the following relations:

H/D₁≧0.5, (D₂+D₃)/D₁≦3.1, D₂/D₃≧0.45

wherein is the distance between a center of the first pivot and a axis X of the fixed handle passed through a center of the fourth pivot, D₁ is the distance between the center of the first pivot and a center of the second pivot, D₂ is the distance between the center of the second pivot and a center of the third pivot, and D₃ is the distance between the center of the third pivot and the center of the fourth pivot.

Further, when the movable handle is exerted on a force to rotate toward the fixed handle until the center of the third pivot falls on a straight line formed by a connection of the center of the second pivot and the center of the fourth pivot, the pair of locking pliers is in a first critical state, and the pair of locking pliers is lockable; when the movable handle further rotates toward the fixed handle to make the center of the third pivot get away from the line formed by a connection of the center of the second pivot and the center of the fourth pivot, the pair of locking pliers is in a locking state, and then the movable handle, the movable jaw and the link are locked.

Further, the link has a first projection, and the first projection is near a forward end of the link; when the pair of locking pliers is in the locking state, the first projection is located in the recess of the movable handle.

Further; the movable handle is further provided with an auxiliary handle in the recess, and the auxiliary handle has a forward end extending toward the movable jaw; when the pair of locking pliers is in the locking state, the first projection contracts the forward end of the auxiliary handle.

Further, the auxiliary handle is located in the recess and is connected with the movable handle by a pin rod.

Further, the forward end of the auxiliary handle is capable of pushing the first projection out of the recess so that the third pivot is capable of moving away from the first pivot, until the center of the third pivot fails on the line formed by a connection of the center of the second pivot and the center of the fourth pivot, the pair of locking pliers is in a second critical state, and the pair of locking pliers is capable of being unlocked; then the movable handle is rotated to make the center of the third pivot get away from the line formed by a connection of the center of the second pivot and the center of the fourth pivot, the pair of locking pliers is in an unlocking state, and then the movable handle, the movable jaw and the link are capable of freely pivoting.

Further, the pair of locking pliers further comprises an adjusting mechanism, wherein the adjusting mechanism is connected to of the second wedge-shaped block using threaded connection.

Further, in the process of rotating the movable handle make the jaw span switch from an opening state to a closing state, and the adjusting mechanism exerts a force on the second wedge-shaped block to make the second wedge-shaped block approach the jaw span.

Further, the opening state refers to a state of the jaw span in the process of the movable jaw moving away from the fixed jaw; the closing state refers to a state of the jaw span in the process of the movable jaw approaching the fixed jaw.

Further, the adjusting mechanism comprises a screw, a connecting part and a spring.

Further, said spring is a tension spring.

Further, the link has a second projection, and second projection is near the rearward end of the link; when the pair of locking pliers is in the unlocking state and the movable handle, the movable jaw and the link are capable of pivoting, the second projection is capable of contacting a head of the screw and exerting a pressure on the head, thus push the second wedge-shaped block-shaped block to move away from the jaw span; when the pair of locking pliers is in the locking state and the movable handle, the movable jaw and the link are locked, the second projection is away from the head.

Further, the second wedge-shaped block is provided with a projecting part, wherein the projecting part is formed by the extending of the second wedge-shaped block, the projecting part is provided with a screw hole, and the screw connects with the projecting part by the screw hole.

Further, the connecting part is connected by a first part and a second part.

Further, the first part which extends toward the jaw span is sleeved on the link and hangs on a hook at one end of the spring; the second part is sleeved on a screw rod of the screw and is located between the head of the screw and the projecting part.

Further, a hook at the other end of the spring is hung on the movable jaw.

Further, the square channel has a first surface and a second surface, wherein the first surface is disposed opposite and spaced from the second surface, and the first surface and the second surface extend along the length of the fixed handle.

Further, the first wedge-shaped block and the second wedge-shaped block- are disposed between the first surface and the second surface.

Further, the first wedge-shaped block and the second wedge-shaped block both have a wide end and a narrow end.

Further, the wide end of the first wedge-shaped block is disposed toward the fixed jaw, and the wide end of the second wedge-shaped block is disposed away from the fixed jaw.

Further, a separating plate is arranged between the first wedge-shaped block and the second wedge and has a pair of parallel upper and lower surfaces; when the first wedge-shaped block squeezes the second wedge-shaped block by the separating plate, the upper surface contacts the first wedge-shaped block and the lower surface contacts the second wedge-shaped block; both two sides of the separating plate have a bulge and the bulge is embedded in the fixed handle.

Further, sides of the fixed handle are provided with an elongated hole and the bulge is embedded in the elongated hole, resulting in the fact that the separating plate only moves along the length of the elongated hole relative to the fixed handle.

Further, the pair of locking pliers also comprises a adjustment mechanism and a clamped working piece, in the process of rotating the movable handle make the jaw span open to clamp the clamped working piece, the second wedge-shaped block moves toward the jaw span through the adjusting mechanism, and the first wedge-shaped block moves away from the jaw span through the link, till the first wedge-shaped block contacts and squeezes the second wedge-shaped block through the separating plate; a extrusion force caused by the first wedge-shaped block squeezing the second wedge-shaped block is transferred to the movable jaw orderly through the link and the movable handle, and makes the movable jaw move toward the fixed jaw; when a movement of the movable jaw toward the fixed jaw is prevented by the clamped working piece, the clamped working piece will suffer from a clamping force.

Further, the adjusting mechanism comprises a screw, and the screw is connected to an end of the second wedge-Shaped block using threaded connection; a distance between the head of the screw and the end of the wedges is inversely proportional to the clamping force.

Further, the fixed jaw and the fixed handle are integrated forming.

Further, the fixed jaw and the movable jaw are both provided with teeth, in order to increase the friction between the clamped working piece and the pliers.

Further, the maximum opening angle of the jaw span reaches 49°.

Further, the first pivot, the second pivot, the third pivot and the fourth pivot are all disposed having two ends with larger diameter and middle part with relatively small diameter.

The invention has the following advantages:

(1) The maximum angle between the movable jaw and the fixed jaw can reach 49° resulting in the fact that the pair of looking pliers in the present invention can efficiently and conveniently clamp large-size working pieces.

(2) The clamping force can be adjusted by rotating the screw, when the position of the screw is fixed, the clamping force is constant, in other words, the clamping force generated by the pair of locking pliers in the present invention has nothing to do with the size of the clamped working piece, so that the clamped working pieces with different sizes can be well clamped by the pair of locking pliers in the present invention.

(3) When the opening span of the pair of locking pliers in the present invention reaches the maximum, the angle between the movable handle and the fixed handle is relatively small, which it is convenient for operating the pair of locking pliers with single hand.

Other features and advantages of the present invention can be obtained by a detailed description with reference to the embodiments and the accompanying drawings for fully understanding.

### BRIEF DESCRIPTION OF THE DRAWINGS

FIG. 1 is a schematic view of the pair of locking pliers in a preferred embodiment of the present invention shown in the closing state;

FIG. 2 is a schematic view of the pair of locking pliers in FIG. 1 when the opening of the jaw span reaches the maximum;

FIG. 3 is another schematic view of the pair of locking pliers in the embodiment of the present invention;

FIG. 4 is a sectional view in the A-A direction in FIG. 1;

FIG. 5 is an exploded view of the pair of locking pliers in the embodiment of the present invention;

FIG. 6 is another exploded view of the pair of locking pliers in the embodiment of the present invention;

FIG. 7 is a schematic view of the main clamp body with its connecting parts in the embodiment of the present invention;

FIG. 8 is an exploded view of the main clamp body with its connecting parts in FIG. 7;

FIG. 9 is a schematic view of the pair of locking pliers in a preferred embodiment of the present invention when clamping the clamped working piece 300.

### DETAILED DESCRIPTION OF THE PREFERRED EMBODIMENTS

The following detailed description together with the accompanying drawings will be provide for the embodiments of the present invention, the embodiments are implemented under the premise of the technical solution of the present invention and provides detail ways of implementing and specific operations, but the scope of protection is not limited to the following embodiments.

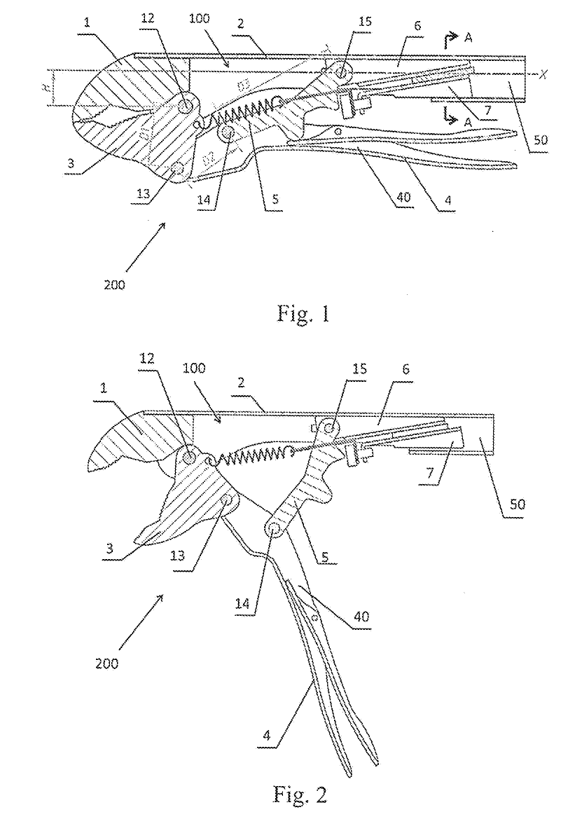

As shown in FIG. 1 and FIG. 2, a preferred embodiment of the present invention provides a pair of locking pliers 200, including a main clamp body 100, a movable jaw 3, a movable handle 4, wedges and a link 5. The main clamp body 100 comprises a fixed jaw 1 fixedly connected with a fixed handle 2 and the fixed handle 2 is provided with a square channel 50. The movable jaw 3 connects with the main clamp body 100 by a first pivot 12 and can be combined with the fixed jaw 1 to form a jaw span. The movable handle 4 connects with the movable jaw 3 by a second pivot 13 and provides with a recess 40, the recess 40 extends along the movable handle 4. The wedges comprise a first wedge-shaped block 6 and a second wedge-shaped block 7 and are disposed in the square channel 50 of the fixed handle 2. The forward end of the link 5 connects with the movable handle 4 by a third pivot 14 and the rearward end of the link 5 extends far away from the jaw span, and the rearward end connects with the first wedge-shaped block 6 by a fourth pivot 15.

When the jaw span reaches maximum as shown in FIG. 2, the pair of locking pliers of the present embodiment satisfies the following relations:

H/D₁≧0.5, (D₂+D₃)/D₁≦3.1, D₂/D₃≧0.45 (1)

In the formula (1), H is the distance between the center of the first pivot 12 and axis X of the fixed handle 2 passed through the center of the fourth pivot 15. D₁ is the distance between the center of the first pivot 12 and the center of the second pivot 13. D₂ is the distance between the center of the second pivot 13 and the center of the third pivot 14. D₃ is the distance between the center of the third pivot 14 and the center of the fourth pivot 15, which is shown in FIG. 1.

When an existing locking pliers clamps working pieces with different sizes, it is needed to adjust the screw to achieve different openings of the jaw span. But in the present embodiment of the invention the jaw span of the pair of locking pliers can be adaptively adjusted by itself according to the size of the clamped working piece, in other words, the jaw span can be adjusted to be suitable for clamped working pieces only through pivoting the movable jaw 3 relative to the fixed jaw 1. The relative locations of the first pivot 12, the second pivot 13, the third pivot 14 and the fourth pivot 15 set according the formula (1) can induce the maximum opening of the jaw span of 49°. Thus the pair of locking pliers in the present embodiment can conveniently clamp large size clamped working pieces.

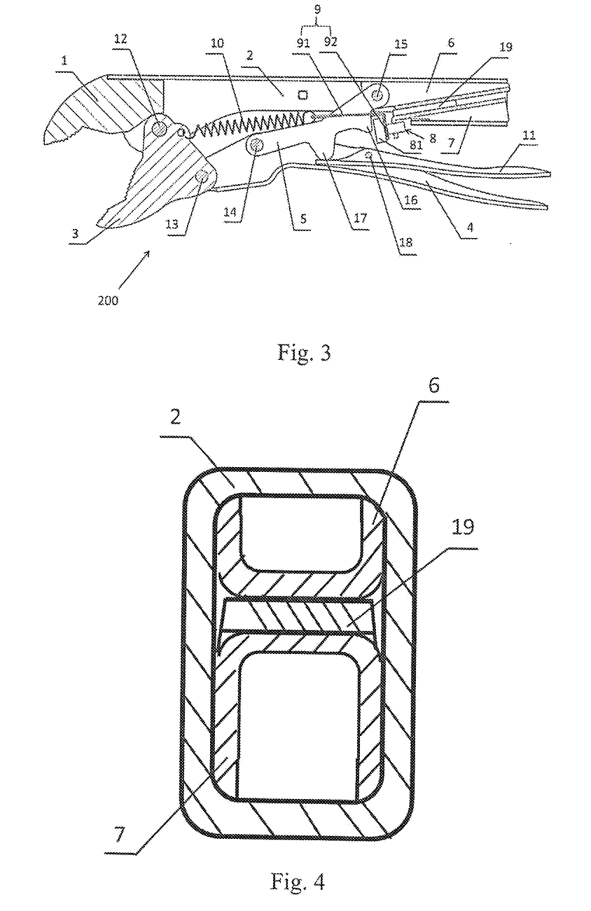

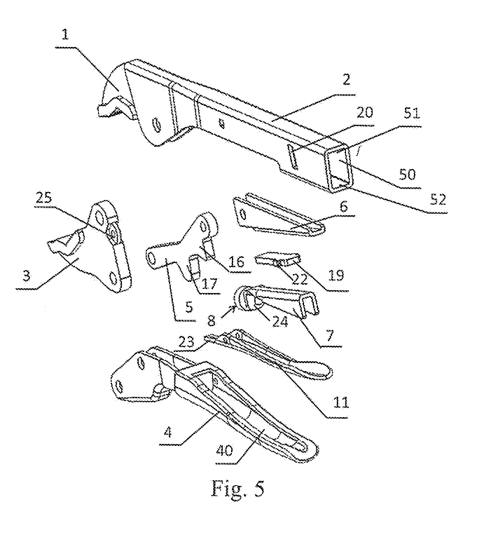

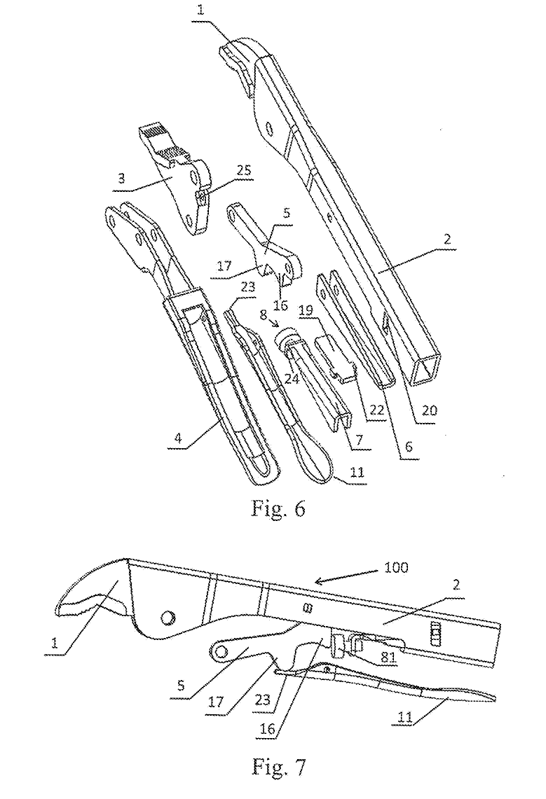

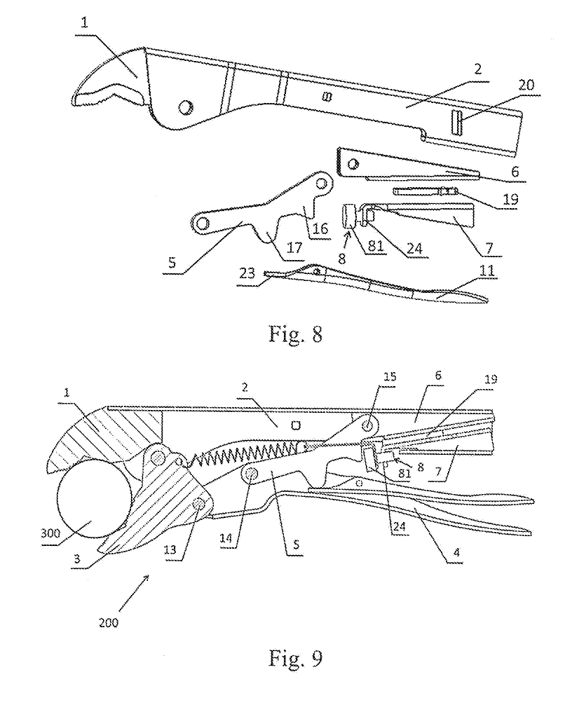

As shown in FIG. 3 to FIG. 8, the pair of locking pliers of the percent embodiment of the invention comprises a fixed jaw 1, a fixed handle 2, a movable jaw 3 and a movable handle 4. The fixed jaw 1 fixedly connects with the fixed handle 2 by means of riveting or welding. The movable jaw 3 and the fixed jaw 2 are connected together by a first pivot 12. The movable jaw 3 can engage the fixed jaw 1 and can also rotate relative to the fixed jaw 1 by the first pivot 12, which can induce the opening and closing of the jaw span. The parts for clamping a clamped working piece on the fixed jaw I and the movable jaw 3 are all provided with teeth, which can increase the friction between the fixed jaw 1, the movable jaw 3 and the clamped working piece and is better far clamping clamped working pieces. The movable handle 4 is connected with the movable jaw 3 by a second pivot 13. The movable jaw 3 is provided with a hanging hole 25.

The fixed handle 2 is provided with a square channel 50, the square channel 50 has a first surface 51 and a second surface 52. The first surface 51 is disposed opposite and spaced from the second surface 52. And the first surface 51 and the second surface 52 extend along the length of the fixed handle 2. The first wedge-shaped block 6 and the second wedge-shaped block 7 are disposed between the first surface 51 and the second surface 52 and they are both provided with a wide end and a narrow end, herein the width of the wide end is greater than that of the narrow end. The wide end of the first wedge-shaped block 6 is disposed toward the fixed jaw 1, and the wide end of the second wedge-shaped block is disposed away from the fixed jaw 1. A separating plate 19 is arranged between the first wedge-shaped block 6 and the second wedge-shaped block 7, the separating plate 19 is preferably a metal plate. The separating plate 19 has a pair of upper surface and lower surface, when the first wedge-shaped block 6 squeezes the second wedge-shaped block 7 by the separating plate 19, referring to FIG. 4, the upper surface of the separating plate 19 contacts the first wedge-shaped block 6 and the lower surface contacts the second wedge-shaped block 7. Both two sides of the separating plate 19 have a bulge 22 and the bulge 22 is embedded in the elongated hole 20 in each side of the fixed handle 2, resulting in the fact that the separating plate 19 only moves along the length of the elongated hole 20 relative to the fixed handle 2.

The pair of locking pliers 200 in the present embodiment further comprises a link 5, the forward end of the link 5 is connected with the movable handle 4 by a third pivot 14 and the rearward end of the link 5 is connected with the first wedge-shaped block 6 by a fourth pivot 15, so that the link 5 can pivot relative to the first wedge-shaped block 6.

In the embodiment of the invention, the first pivot, the second pivot, the third pivot and the fourth pivot are all disposed having two ends with larger diameter and middle part with relatively small diameter they can be rivets, or fastener s consisting of nuts and bolts in other embodiments, The diameter of the middle part of each pivot is less than that of the corresponding pivot hole, which is convenient for pivoting the components at each pivot.

The pair of locking pliers of the embodiment further includes an adjusting mechanism; preferably, the adjusting mechanism comprises the screw 8, the connecting part 9 and the spring 10. The spring 10 is a tension spring in a prefer embodiment of the invention. The second wedge-shaped block 7 is provided with a projecting part 24, herein the projecting part 24 is formed through the extending of the second wedge-shaped block 7 and has a screw hole, The screw 8 connects with the projecting part 24 by the screw hole, The connecting part 9 is provided with a first part 91 extending toward the jaw span and a second part 92. The first part 91 is sleeved on the link 5 and hangs on the hook at one end of the spring 10. The second part 92 is sleeved on the screw rod of the screw 8 and is located between the head 81 of the screw 8 and the projecting part 24 of the second wedge-shaped block 7. The hook at the other end of the spring 10 is hung in the hanging hole 25 of the movable jaw 3.

In the embodiment of the invention, when an operator exert a force on the movable handle 4 to make it rotate toward the fixed handle 2 through the second pivot, the third pivot 14 approaches the first pivot 12, until the center of the third pivot 14 falls on the line connecting the center of the second pivot 13 and the center of the fourth pivot 15, then the pair of locking pliers is in a first critical state, and the pair of locking pliers can be locked; then make the movable handle 4 further rotate toward the fixed handle 3 until the distance between the third pivot 14 and the first pivot 12 reaches the minimum and the center of the third pivot 14 get away from the line connecting the center of the second pivot 13 and the center of the fourth pivot 15, the pair of locking pliers is in a locking state, and then the movable handle 4, the movable jaw 3 and the link 5 are locked.

The link 5 is provided with a first projection 17, in the process of the movable handle 4 rotating toward the fixed handle 2, the link 5 pivots through the third pivot 14 and the fourth pivot 15, resulting in the fact that the first projection 17 moves toward the recess 40 of the movable handle 4 till enters into the recess 40, thus the pair of locking pliers is locked.

The movable handle is further provided with an auxiliary handle 11 in the recess, the auxiliary handle 11 is installed with the movable handle 4 via a pin rod 18. The auxiliary handle 11 has a forward end 23 extending toward the movable jaw 3. When the pair of locking pliers is in the locking state, the first projection 17 of the link 5 contracts the forward end 23 of the auxiliary handle 11. At this moment, if the small handle 11 is exerted a force to make the auxiliary handle 11 rotate toward the movable handle 4, according to the Law of the Lever, the force exerted on the auxiliary handle is transferred to the first projection 17 through the forward end 23, then the forward end 23 can easily push the first projection 17 out of the recess 40 so that the third pivot 14 can move away from the first pivot 12, until the center of the third pivot 14 falls on the line connecting the center of the second pivot 13 and the center of the fourth pivot 15, thus the pair of locking pliers is in a second critical state, and the pair of locking pliers can be unlocked. At this moment, rotating the movable handle 4 to make the third pivot 14 continue to move away from the first pivot 12 until the center of the third pivot 14 get away from the line connecting the center of the second pivot 13 and the center of the fourth pivot 15, then the pair of locking pliers is in an unlocking state, and the movable handle 4, the movable jaw 3 and the link 5 can freely pivot.

The link 5 is further provided with a second projection 16, when the pair of locking pliers is in the unlocking state, the second projection 16 can contact the head 81 of the screw 8 and exert a pressure on the head 81, thus push the second wedge-shaped block 7 to move away from the jaw span. When the pair of locking pliers is in the locking state, the second projection 16 is away from the head 81 of the screw 8, and then no interaction forces occur between the second projection 16 and the head 81.

In the actual operation, the operators can exert a force on the movable handle 4 to make the movable handle 4 rotate toward or away from the fixed handle 2, so that the jaw span switches from an opening state to a closing state or from a closing state to an opening state. Herein the opening state refers to the state of the jaw span in the process of the movable jaw 3 moving away from the fixed jaw I and the closing state refers to the state of the jaw span in the process of the movable jaw 3 approaching the fixed jaw 1. FIG. 9 shows the pair of locking pliers 200 of a preferred embodiment of the present invention clamping the clamped working piece 300. In the process of rotating the movable handle 4 to make the jaw span open to clamp the clamped working piece 300, that is, when rotating the movable handle 4 to make the movable jaw 3 which is away from the fixed jaw 1 approach the fixed jaw 1 till the clamped working piece 300 is clamped, the adjusting mechanism exerts a pulling force on the second wedge-shaped block 7 so that the second wedge-shaped block 7 moves toward the jaw span. At the same time, the link 5 pushes the first wedge-shaped block 6 to move away from the jaw span, when the first wedge-shaped block 6 moves to contact the separating plate 19, the first wedge-shaped block 6 compresses the separating plate 19 till the separating plate 19 contacts the second wedge-shaped block 7. At the moment, if the first wedge-shaped block 6 continues to move away from the jaw span, the first wedge-shaped block 6 will squeezes the second wedge-shaped block 7 by the separating plate 19. The extrusion force caused by the first wedge-shaped block 6 squeezing the second wedge-shaped block 7 is transferred to the movable jaw 3 through the link 5 and the movable handle 4, which makes the movable jaw 3 move toward the fixed jaw 1, when the movement of the movable jaw 3 toward the fixed jaw 1 is prevented by the clamped working piece 300, the clamped working piece 300 has suffered from a clamping force.

In the present embodiment of the invention, the clamping force caused by the pair of locking pliers 200 clamping the clamped working piece 300 has nothing to do with the size of the clamped working piece 300, and the clamping force is achieved by adjusting the screw 8 of the adjusting mechanism. The clamping force lies on the distance between the projecting part 24 of the second wedge-shaped block 7 and the head 81 of the screw 8. When rotating the screw 8 to make the head part 81 move toward the jaw span and away from the projecting part 24 of the second wedge-shaped block 7, the second wedge-shaped block 7 moves backward and away from the jaw span. As the second wedge-shaped block 7 is provided with the wide end and the narrow end and the wide end is far away from the fixed jaw 1, the first wedge-shaped block 6 needs to move backward farther to contact and squeeze the second wedge-shaped block 7 if the second wedge-shaped block 7 move backward farther. When the first wedge-shaped block 6 moves backward farther, the angle, which is between the line connecting the center of the second pivot 13 and the center of the third pivot 14 and the other line connecting the center of the third pivot 14 and the center of the fourth pivot 15, gets larger. In this situation, the deformation of the link 5 caused by the first wedge-shaped block 6 squeezing the second wedge-shaped block 7 is smaller, and the applied force on the movable jaw 3 transferred from the movable handle 4 gets smaller, then the distance for the movable jaw 3 moving to the fixed jaw 1 is shorter, resulting in a smaller clamping force on the clamped working piece 300.

On the contrary, when rotating the screw 8 to make the head 81 move away from the jaw span and approach the projecting part 24 of the second wedge-shaped block 7, the second wedge-shaped block 7 moves forward toward the jaw span. If the second wedge-shaped block 7 is closer to the jaw span, the first wedge-shaped block 6 moves backward a distance to contact and squeeze the second wedge-shaped block 7. When the first wedge-shaped block 6 moves forward and is closer to the jaw span, the angle, which is between the line connecting the center of the second pivot 13 and the center of the third pivot 14 and the other line connecting the center of the third pivot 14 and the center of the fourth pivot 15, gets smaller. In this situation, the deformation of the link 5 caused by the first wedge-shaped block 6 squeezing the second wedge-shaped block 7 is larger, and the applied force on the movable jaw 3 transferred from the movable handle 4 is larger. then the distance for the movable jaw 3 moving to the fixed jaw 1 gets longer, resulting in a larger clamping force on the clamped working piece 300.

For the clamped working piece 300 with different sizes, as long as the distance between the head 81 of the screw 8 and the projecting part 24 of the second wedge-shaped block 7 is fixed, the clamp force on the clamped working piece is fixed.

In addition, in the present embodiment of the invention, when the span of the pair of locking pliers 200 reaches the maximum, the angle between the movable handle 4 and the fixed handle 2 is less than that of the existing locking pliers, which is convenient for operating the pair of locking pliers with single hand.

The invention has been exemplified above with reference to specific embodiments. However, it should be understood that a multitude of modifications and varieties can be made by a common person skilled in the art based on the conception of the present invention. Therefore, any technical schemes, acquired by the person skilled in the art based on the conception of the present invention through logical analyses, deductions or limited experiments, fall within the scope of the invention as specified in the claims.

1. A pair of locking pliers, characterized by comprising:
a main clamp body formed by a fixedly connection of a fixed jaw and a fixed handle, wherein the fixed handle is provided with a square channel;
a movable jaw connected with the main clamp body via a first pivot and capable of combining the fixed jaw to form a jaw span;
a movable handle connected with the movable jaw via a second pivot and provided with a recess which extends along the movable handle;
a wedge-shaped piece disposed in the square channel of the fixed handle and the wedge-shaped piece which comprises a first wedge-shaped block and a second wedge-shaped block;
a link, wherein a forward end of the link is connected with the movable handle by a third pivot, a rearward end of the link extends far away from the jaw span, and the rearward end is connected with the first wedge-shaped block by a fourth pivot;
wherein the pair of locking pliers is configured such that: when the jaw span reaches maximum, the pair of locking pliers satisfies the following relations:
H/D₁≧0.5, (D₂+D₃)/D1≦3.1, D₂/D₃≧0.45
wherein H is the distance between a center of the first pivot and a axis X of the fixed handle passing through a center of the fourth pivot, D₁ is the distance between the center of the first pivot and a center of the second pivot, D₂ is the distance between the center of the second pivot and a center of the third pivot, and D₃ is the distance between the center of the third pivot and the center of the fourth pivot.

2. The pair of locking pliers according to claim 1, characterized in that when a force is exerted to the movable handle to rotate toward the fixed handle until the center of the third pivot falls on a line formed by a connection of the center of the second pivot and the center of the fourth pivot, the pair of locking pliers is in a first critical state, and the pair of locking pliers is lockable; when the movable handle further rotates toward the fixed handle to make the center of the third pivot get away from the line formed by a connection of the center of the second pivot and the center of the fourth pivot, the pair of locking pliers is in a locking state, and then the movable handle, the movable jaw and the link are locked.

3. The pair of locking pliers according to claim 2, characterized in that the link is provided with a first projection, and the first projection is near a forward end of the link; when the pair of locking pliers is in the locking state, the first projection is located in the recess of the movable handle.

4. The pair of locking pliers according to claim 3, characterized in that the movable handle is further provided with an auxiliary handle in the recess, and the auxiliary handle is provided with a forward end extending toward the movable jaw; when the pair of locking pliers is in the locking state, the first projection contacts the forward end of the auxiliary handle.

5. The pair of locking pliers according to claim 4, characterized in that the forward end of the auxiliary handle is capable of pushing the first projection out of the recess so that the third pivot is capable of moving away from the first pivot, until the center of the third pivot falls on the line formed by a connection of the center of the second pivot and the center of the fourth pivot, the pair of locking pliers is in a second critical state, and the pair of locking pliers is capable of being unlocked; then the movable handle is rotated to make the center of the third pivot get away from the line formed by a connection of the center of the second pivot and the center of the fourth pivot, the pair of locking pliers is in an unlocking state, and the movable handle, the movable jaw and the link are capable of freely pivoting.

6. The pair of locking pliers according to claim 1, characterized by further comprising an adjusting mechanism, wherein the adjusting mechanism is connected to the second wedge-shaped block using threaded connection.

7. The pair of locking pliers according to claim 6, characterized in that in the process of rotating the movable handle make the jaw span switch from an opening state to a closing state, and the adjusting mechanism exerts a force on the second wedge-shaped block to make the second wedge-shaped block approach the jaw span.

8. The pair of locking pliers according to claim 7, characterized in that the opening state refers to a state of the jaw span in the process of the movable jaw moving away from the fixed jaw; the closing state refers to a state of the jaw span in the process of the movable jaw approaching the fixed jaw.

9. The pair of locking pliers according to claim 6, characterized in that the adjusting mechanism comprises a screw, a connecting part and a spring.

10. The pair of locking pliers according to claim 9, characterized in that the link is provided with a second projection, and the second projection is near the rearward end of the link; when the pair of locking pliers is in the unlocking state and the movable handle, the movable jaw and the link are capable of pivoting, the second projection is capable of contacting a head of the screw and exerting a pressure on the head to push the second wedge-shaped block to move away from the jaw span; when the pair of locking pliers is in the locking state and the movable handle, the movable jaw and the link are locked, the second projection is away from the head.

11. The pair of locking pliers according to claim 9, characterized in that the second wedge-shaped block is provided with a projecting part, the projecting part is formed by the extending of the second wedge-shaped block, the projecting part is provided with a screw hole, and the screw connects with the projecting part through the screw hole via threaded connection.

12. The pair of locking pliers according to claim 11, characterized in that the connecting part is formed by a connection of a first part and a second part; the first part which extends toward the jaw span is sleeved on the link and hangs on a hook at one end of the spring; the second part is sleeved on a screw rod of the screw and located between the head of the screw and the projecting part; a hook at the other end of the spring hangs on the movable jaw.

13. The pair of locking pliers according to claim 1, characterized in that the square channel is provided with a first surface and a second surface, the first surface is disposed opposite and spaced from the second surface, and the first surface and the second surface extend along the length of the fixed handle.

14. The pair of locking pliers according to claim 13, characterized in that the first wedge-shaped block and the second wedge-shaped block are disposed between the first surface and the second surface.

15. The pair of locking pliers according to claim 1, characterized in that the first wedge-shaped block and the second wedge-shaped block both have a wide end and a narrow end; the wide end of the first wedge-shaped block is disposed toward the fixed jaw, and the wide end of the second wedge-shaped block is disposed away from the fixed jaw.

16. The pair of locking pliers according to claim 1, characterized in that a separating plate is arranged between the first wedge-shaped block and the second wedge-shaped block, the separating plate is provided with an upper surface and a lower surface which are parallel to each other; when the first wedge-shaped block squeezes the second wedge-shaped block through the separating plate, the upper surface contacts the first wedge-shaped block and the lower surface contacts the second wedge-shaped block; each of the two sides of the separating plate is provided with a bulge and the bulge is embedded in the fixed handle.

17. The pair of locking pliers according to claim 16, characterized in that sides of the fixed handle are provided with an elongated hole and the bulge is embedded in the elongated hole, resulting in that the separating plate is capable of only moving along the length of the elongated hole relative to the fixed handle.

18. The pair of locking pliers according to claim 16, characterized in that the pair of locking pliers further comprises an adjustment mechanism and a clamped working piece, in the process of rotating the movable handle make the jaw span open to clamp the clamped working piece, the second wedge-shaped block moves toward the jaw span through the adjusting mechanism, and the first wedge-shaped block moves away from the law span through the link, till the first wedge-shaped block contacts and squeezes the second wedge-shaped block through the separating plate; a extrusion force caused by the first wedge-shaped block squeezing the second wedge-shaped block is transferred to the movable jaw orderly through the link and the movable handle, and makes the movable jaw move toward the fixed jaw; when a movement of the movable jaw toward the fixed jaw is prevented by the clamped working piece, the clamped working piece Will suffer from a clamping force.

19. The pair of locking pliers according to claim 18, characterized in that the adjusting mechanism comprises a screw, and the screw is connected to a end of the second wedge-shaped block using threaded connection; a distance between the head of the screw and the end of the wedges is inversely proportional to the clamping force.

20. The pair of locking pliers according to claim 1, characterized in that the maximum opening angle of the jaw span reaches 49°.
